(19) United States
(12) Patent Application Publication
(10) Pub. No.: US 2026/0299322 A1
(43) Pub. Date: Oct. 1, 2026

(54) PREPARATION METHOD AND APPLICATION FOR FERROELECTRIC LIQUID CRYSTAL MATERIAL GRATING AT ROOM TEMPERATURE BASED ON FEMTOSECOND LASER DIRECT WRITING

(71) Applicant: NANJING UNIVERSITY, Nanjing City (CN)

(72) Inventors: Lingling MA, Nanjing City (CN); Yanqing LU, Nanjing City (CN); Keyi GUO, Nanjing City (CN); Xiaoyi XU, Nanjing City (CN); Jintao PAN, Nanjing City (CN); Chao CHEN, Nanjing City (CN); Yong ZHANG, Nanjing City (CN); Yang WEI, Nanjing City (CN)

(21) Appl. No.: 19/464,723

(22) Filed: Jan. 30, 2026

(30) Foreign Application Priority Data
Feb. 12, 2025 (CN) 202510155709.7

(51) Int. Cl. G02F 1/00; G02F 1/13; G02F 1/1337; G02F 1/1341; G02F 1/141

(52) U.S. Cl. CPC G02F 1/0045; G02F 1/1316; G02F 1/133788; G02F 1/1341; G02F 1/141; G02F 2201/30; G02F 2202/02

(57) ABSTRACT

A preparation method and an application for a ferroelectric liquid crystal material grating at room temperature based on femtosecond laser direct writing are provided. The first substrate and second substrate are cleaned by ultrasound, and cleaned by ozone after dried; spacers are applied to edges of cleaned first substrate and second substrate, and two substrates are bonded in a staggered manner and formed a liquid crystal cell after cured; a ferroelectric liquid crystal material is injected into the liquid crystal cell to form a liquid crystal layer; patterns are directly written on the liquid crystal layer by a femtosecond laser direct writing device to control a molecular orientation direction of the liquid crystal layer, the ferroelectric liquid crystal material grating is obtained. The patterns directly written on the liquid crystal layer include any one of strip patterns, radial line patterns and circular ring patterns.

### CROSS-REFERENCE TO RELATED APPLICATIONS

This application claims priority to Chinese Patent Application No. 202510155709.7, filed on Feb 12, 2025, the contents of which are hereby incorporated by reference.

### TECHNICAL FIELD

The present disclosure belongs to the field of optical technology, and specifically relates to a preparation method and an application for a ferroelectric liquid crystal material grating at room temperature based on femtosecond laser direct writing.

### BACKGROUND

Ferroelectric materials have the characteristic of spontaneous polarization, and their polarization direction may be switched by an external electric field, so they have a wide range of applications in the fields of electronics, electro-optics and mechatronics. Among them, materials such as LiNbO3 that have been widely used in the optical field belong to inorganic metal ferroelectric crystals. To realize their multi-field applications in modern scientific and technological research, various domain engineering technologies such as electric polarization and femtosecond laser direct writing have been proposed to regulate the spontaneous polarization of ferroelectric materials. In addition, organic ferroelectric materials have the advantages of light weight, good flexibility, strong adjustability, non-toxicity, good biocompatibility, low cost and low power consumption, and have great application potential in fields such as biomedicine and optoelectronic devices. The utilization of various domain engineering technologies in organic ferroelectrics is still in the research upsurge.

As a well-known organic material, liquid crystals have both the fluidity of liquids and the anisotropy of crystals. They are sensitive to external stimuli, and also have unique anisotropic optical properties, self-assembly capabilities and dynamic adjustability. A new type of liquid crystal discovered in recent years—ferroelectric nematic liquid crystal, breaks the head-tail symmetry compared with traditional liquid crystals, has spontaneous polarization characteristics, large dielectric constant and strong nonlinear optical response, and is very suitable for realizing programmable and dynamic structured light field manipulation in the field of nonlinear optics. In the past few years, research on the control of polar order in such organic ferroelectric materials has achieved many important achievements. However, the existing ferroelectric nematic liquid crystals such as RM734 and DIO are limited by temperature. Under the condition of unstable temperature control, the material may easily crystallize, showing a disordered and defective polycrystalline phase at room temperature. It is generally believed that such a crystalline state may be difficult to apply. Therefore, it is necessary to explore a method that may manipulate and utilize ferroelectric liquid crystals at room temperature, so as to open up new possibilities for their flexible applications in fields such as new optoelectronic and advanced photonic device design.

### SUMMARY

The technical problem to be solved by the present disclosure is to address the deficiencies of the prior art, and provide a method that uses femtosecond laser direct writing technology to regulate the molecular orientation direction of ferroelectric liquid crystal materials at room temperature to obtain fine patterned structures, and utilizes the characteristic of liquid crystals responding to external stimuli to realize applications in the field of nonlinear photonics. The present disclosure realizes the manipulation of liquid crystal structures at room temperature through femtosecond laser direct writing technology, and solves the problems existing in the application of current ferroelectric nematic liquid crystals, such as the need to control the temperature of liquid crystal elements and the heating and cooling rates to prevent defects caused by material crystallization and disordered liquid crystal structures.

In order to solve the above technical problems, the present disclosure discloses a method for preparing a ferroelectric liquid crystal material grating at room temperature based on femtosecond laser direct writing, including following specific steps:

cleaning a first substrate and a second substrate by ultrasound, and cleaning the first substrate and the second substrate by ozone after drying to obtain a cleaned first substrate and a cleaned second substrate

applying spacers to edges of the cleaned first substrate and the cleaned second substrate, bonding the cleaned first substrate and the cleaned second substrate in a staggered manner, and forming a liquid crystal cell after curing;

injecting a ferroelectric liquid crystal material into the liquid crystal cell to form a liquid crystal layer; and

directly writing patterns on the liquid crystal layer by a femtosecond laser direct writing device to control a molecular orientation direction of the liquid crystal layer, and obtaining the ferroelectric liquid crystal material grating;

where, the patterns directly written on the liquid crystal layer by the femtosecond laser direct writing device include any one of strip patterns, radial line patterns and circular ring patterns.

Optionally, a first alignment layer and a second alignment layer are respectively disposed on inner sides of the first substrate and the second substrate.

Specifically, width of the strip pattern increases as femtosecond laser power in the femtosecond laser direct writing device increases.

Specifically, the femtosecond laser direct writing device includes a femtosecond laser, a shutter, a half-wave plate, a polarization beam splitter, a polarizer, a lens, a diaphragm, a charge coupled device (CCD) camera, a reflector, a first microscope objective, a second microscope objective, a liquid crystal sample and a high-precision translation stage.

Optionally, the femtosecond laser generates laser light with a wavelength of 800 nanometers, a duration of 75 femtoseconds and a repetition frequency of 80 megahertz.

Optionally, the femtosecond laser direct writing device includes the first microscope objective with a numerical aperture of 0.7 and a magnification of 50 times, and the second microscope objective with a numerical aperture of 0.3 and a magnification of 10 times.

In an embodiment, the method for manipulating the structure of the ferroelectric liquid crystal material at room temperature according to the present disclosure may adjust the size and pattern of the obtained liquid crystal ferroelectric domain structure by setting parameters (laser power, direct writing speed, focusing depth, etc.) of the femtosecond laser direct writing system and the movement trajectory of the laser spot, therefore, it is expected to expand the application of liquid crystal elements obtained by directly writing to more fields.

Specifically, the liquid crystal layer material adopts a ferroelectric liquid crystal material to realize nonlinear optical response sensitive to external stimuli. The ferroelectric liquid crystal materials have spontaneous polarization characteristics and may regulate the incident light field. The nonlinear liquid crystal element according to the present disclosure selects ferroelectric nematic liquid crystal RM734, but is not limited to this material.

Specifically, alignment agent used in the first alignment layer and the second alignment layer includes any one of surfactants, rubbing alignment agents, photocrosslinkable materials, photodegradable materials and photochromic cis-trans isomerization materials.

Optionally, the alignment agent is an azo-based photo-controlled alignment material SD1 or a rubbing alignment agent polyimide (PI);

where the molecules of the photo-controlled alignment material will arrange along the direction perpendicular to the linearly polarized light under the irradiation of linearly polarized light, and interact with the liquid crystal molecules to make the liquid crystal molecules form an ordered orientation, thereby realizing the control of the liquid crystal molecular orientation; the rubbing alignment agent will arrange along the rubbing direction under the action of friction force, and induce the alignment along the arrangement direction of the alignment agent molecules through the interaction with the liquid crystal molecules. In practical operation, it is not limited to these two materials.

More optionally, the alignment agent is an azo-based photo-controlled alignment material SD1.

Specifically, the ultrasonic cleaning includes indium tin oxide (ITO) cleaning solution ultrasonic cleaning and ultrapure water ultrasonic cleaning; where the duration of ITO cleaning solution ultrasonic cleaning is 30 minutes, and the ultrapure water ultrasonic cleaning is divided into two times, each with a duration of 10 minutes.

Specifically, the drying conditions are: 120 degrees Celsius, and the drying duration is 40 minutes.

Specifically, the spacer is a mixture of microspheres and frame sealing adhesive; where the microspheres are silica microspheres or polystyrene microspheres with a particle size of 10 micrometers.

Specifically, the liquid crystal layer is formed by heating the ferroelectric nematic liquid crystal material RM734 to 188 degrees Celsius and injecting it into the liquid crystal cell through a capillary glass tube.

Specifically, the first alignment layer and the second alignment layer are formed by spin-coating an alignment agent on the inner sides of the first substrate and the second substrate and annealing.

Optionally, the spin-coating conditions are: first step, spin-coating at 800 revolutions per minute for 8 seconds; second step, spin-coating at 3000 revolutions per minute for 40 seconds.

Optionally, the annealing conditions are: temperature of 100 degrees Celsius and time of 10 minutes.

Specifically, in the preparation process of the ferroelectric liquid crystal material grating containing the first alignment layer and the second alignment layer, it is necessary to pre-align the first alignment layer and the second alignment layer after forming the liquid crystal cell and before injecting the ferroelectric liquid crystal material. The specific operation is: uniformly pre-align the first alignment layer and the second alignment layer with linearly polarized light having a wavelength of 405 nanometers and a power of 1 watt (W) to 2W.

In an embodiment, the ferroelectric liquid crystal material grating at room temperature based on femtosecond laser direct writing prepared by the above preparation method is also within the protection scope of the present disclosure.

In an embodiment, the application of the above ferroelectric liquid crystal material grating at room temperature based on femtosecond laser direct writing in realizing linear and/or nonlinear grating diffraction is also within the protection scope of the present disclosure.

Specifically, in some embodiments of the present disclosure, a grating structure is directly written with a femtosecond laser power of 350 megawatts (mW) and a period of 20 micrometers (μm). The incident light wavelength is set to 800 nanometers (nm), and linear and nonlinear diffraction spots of the grating are obtained respectively. The nonlinear diffraction of the grating conforms to nonlinear Raman-Nath diffraction, with symmetrically distributed multi-order diffracted lights, and the 0th-order spot has the strongest light intensity. The first-order diffraction angle of linear diffraction is twice that of nonlinear diffraction; which proves the application prospect of the above liquid crystal grating in realizing linear and/or nonlinear grating diffraction.

Beneficial effects of the present disclosure are as follows.

The present disclosure realizes the in-plane arbitrary angle control of the polarization direction of polar liquid crystal molecules at room temperature through femtosecond laser direct writing technology. The thermal electric field induced at the focus of the femtosecond laser drives the arrangement of liquid crystal molecules, without being limited to the traditional alignment methods (such as photo-controlled alignment, rubbing alignment, etc.) that rely on alignment agents to induce the orientation of liquid crystal molecules, and avoids the splay arrangement problem caused by the flexoelectric effect of the ferroelectric nematic liquid crystal system, as well as the problem of structural defects caused by temperature changes in traditional alignment methods. The ferroelectric liquid crystal material grating is prepared at room temperature by femtosecond laser direct writing technology, and the nonlinear optical beam steering control is successfully realized.

### BRIEF DESCRIPTION OF THE DRAWINGS

The present disclosure will be described in further detail below with reference to the accompanying drawings and specific embodiments, and the above and/or other advantages of the present disclosure will become clearer.

FIG. 1 is a structural diagram of a liquid crystal element prepared in an embodiment of the present disclosure.

FIG. 2 is a texture diagram under a polarizing microscope and its brightness information change of the liquid crystal element after uniform pre-alignment prepared in an embodiment of the present disclosure at room temperature.

FIG. 3 is a schematic diagram of a femtosecond laser direct writing device used in the present disclosure.

FIG. 4 is a schematic diagram of the orientation change of a femtosecond laser direct writing ferroelectric liquid crystal element prepared in an embodiment of the present disclosure.

FIG. 5 is a texture diagram of a strip structure of a ferroelectric liquid crystal material at room temperature prepared in an embodiment of the present disclosure under a polarizing microscope.

FIG. 6A is a texture diagram of femtosecond laser direct writing radial lines patterns prepared in an embodiment of the present disclosure under a polarizing microscope.

FIG. 6B is a texture diagram of femtosecond laser direct writing circular ring patterns prepared in an embodiment of the present disclosure under a polarizing microscope.

FIG. 7A and FIG. 7B are a texture diagram of a grating prepared in an embodiment of the present disclosure under a polarizing microscope and its corresponding linear and nonlinear diffraction diagrams.

FIG. 8 is a flowchart of the method for preparing a ferroelectric liquid crystal material grating at room temperature based on femtosecond laser direct writing.

### DETAILED DESCRIPTION OFTHE EMBODIMENTS

To make the objectives, technical schemes and advantages of the embodiments of the present disclosure clearer, the technical schemes of the embodiments of the present disclosure will be clearly and completely described below with reference to the accompanying drawings of the embodiments of the present disclosure. Apparently, the described embodiments are part of the embodiments of the present disclosure, not all of them.

Unless otherwise defined, the technical terms or scientific terms used herein shall have the usual meanings understood by those with ordinary skills in the field to which the present disclosure belongs.

The experimental methods described in the following embodiments are conventional methods unless otherwise specified; the reagents and materials used are commercially available unless otherwise specified.

### Embodiment 1

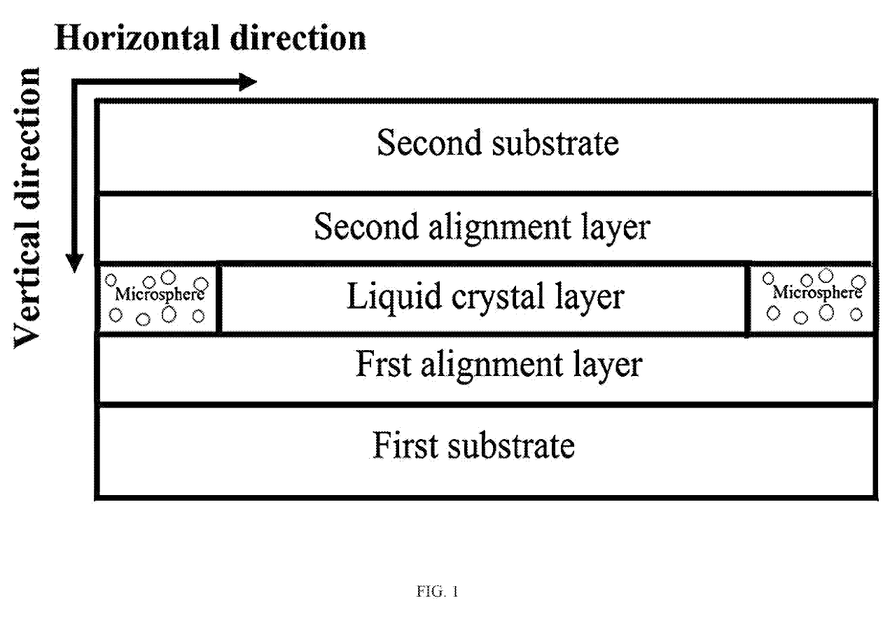

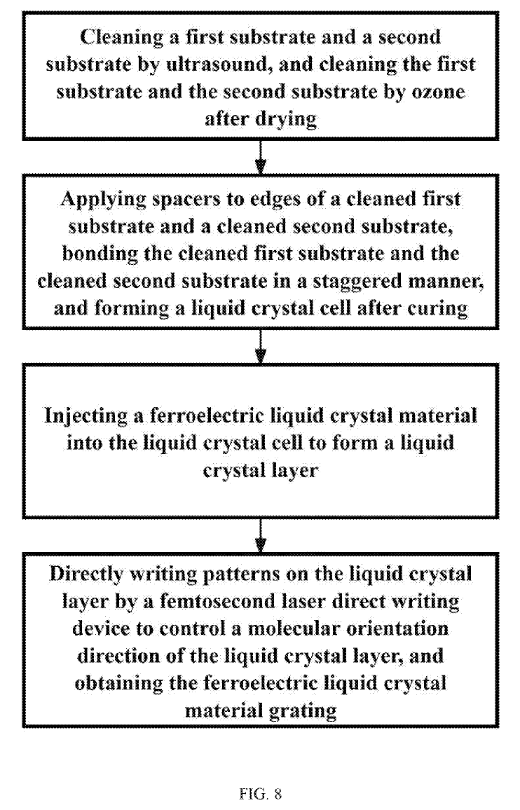

The present disclosure proposes a preparation method and an application for a ferroelectric liquid crystal material grating at room temperature based on femtosecond laser direct writing. FIG. 1 is a structural diagram of a liquid crystal element prepared in this embodiment, which specifically includes a first substrate and a second substrate. Inner sides of the first substrate and the second substrate are provided with a first alignment layer and a second alignment layer. The edges of the first substrate and the second substrate are provided with microspheres. After the first substrate and the second substrate are bonded, a liquid crystal cell is formed between them. A liquid crystal material is injected into the liquid crystal cell to form a liquid crystal layer. The preparation steps of the liquid crystal grating are as follows (as shown in FIG. 8).

Step 1: both the first substrate and the second substrate adopt indium tin oxide (ITO) glass substrates. First, the first substrate and the second substrate are ultrasonically cleaned with ITO cleaning solution for 30 minutes. Then, they are repeatedly ultrasonically cleaned with ultrapure water twice, each cleaning time is 10 minutes. The cleaned substrates are placed in an oven, the temperature of the oven is adjusted to 120 degrees Celsius, the drying duration is 40 minutes, and finally the glass substrates are cleaned with ultraviolet ozone for 30 minutes.

Step 2: a photo-alignment agent SD1 is spin-coated on the first substrate and the second substrate. The specific spin-coating method is: first step, spin-coating at 800 revolutions per minute for 8 seconds; second step, spin-coating at 3000 revolutions per minute for 40 seconds. The thickness of the finally formed photo-alignment agent layer is about 30 nanometers. After spin-coating the alignment agent, the glass substrates spin-coated with the photo-controlled alignment agent SD1 are annealed to form a first alignment layer and a second alignment layer. The annealing temperature is 100 degrees Celsius and the time is 10 minutes.

Step 3: a mixture of microspheres and UV frame sealing adhesive is used as a spacer, where the microspheres are 10-micrometer silica microspheres or polystyrene microspheres. After uniform mixing, they are applied to edges of the first substrate and the second substrate. The upper and lower substrates are bonded in a staggered manner and placed under ultraviolet light until the frame sealing adhesive is cured to form a liquid crystal cell. The cell thickness is controlled by changing the diameter of the microspheres. The cell thickness of the liquid crystal cell in this embodiment is measured to be about 9.6 micrometers by interferometry.

Step 4: the first alignment layer and the second alignment layer are uniformly aligned with linearly polarized light having a wavelength of 405 nanometers. A 405-nanometer light-emitting diode (LED) light source with a power of 1 watt (W) to 2W is used, and after passing through a polarizer, it fully irradiates on the liquid crystal cell to directly perform uniform in-plane alignment on the first and second alignment layers.

Step 5: a liquid crystal material is filled between the first substrate and the second substrate. The ferroelectric nematic liquid crystal material RM734 is heated to 188 degrees Celsius and injected into the liquid crystal cell through a capillary glass tube to make the liquid crystal molecules arrange according to the orientation direction of the first alignment layer and the second alignment layer. After the filling is completed, the liquid crystal cell is cooled to room temperature.

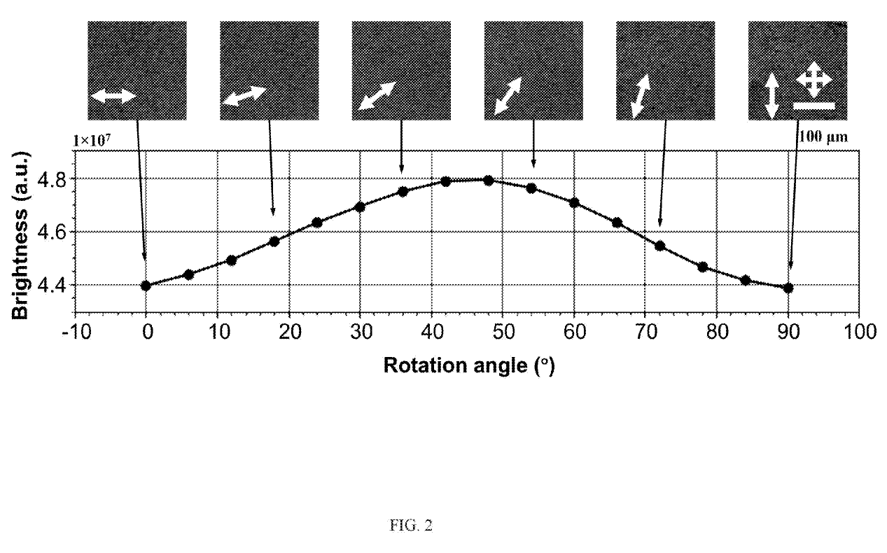

The liquid crystal molecular orientation of the liquid crystal element obtained in step 5 is studied. FIG. 2 is a texture diagram under a cross-polarized microscope and its brightness information change of the uniformly aligned liquid crystal element after cooling to room temperature. It may be seen from the figure that the liquid crystal texture presents a disordered state at room temperature, and the uniform alignment effect is destroyed. Under the cross-polarized microscope, when the sample is rotated, no extinction of the texture brightness is found, and the brightness change is less than 10%, which may indicate that the optical anisotropy induced by alignment is very weak at this time. The texture diagram and its brightness change law here prove that the traditional liquid crystal alignment methods such as intermolecular forces and surface structure induction of oriented molecules through alignment layers do not achieve the expected control of liquid crystal polarization direction.

Step 6: the femtosecond laser is focused into the liquid crystal layer by a femtosecond laser direct writing device, and a thermal gradient field formed at the laser focus induces a thermal electric field. The polarization direction of the ferroelectric liquid crystal molecules is regulated under the action of the thermal electric field and arranged along the electric field direction. As the laser focus moves, the position of the thermal electric field moves correspondingly, driving the reorientation of the polarization direction at the position after the movement of the thermal electric field to form a ferroelectric domain structure. Multiple strip domain structures directly written at equal intervals may obtain the ferroelectric liquid crystal material grating at room temperature based on femtosecond laser direct writing.

Among them, the position covered by the thermal electric field after movement will rewrite the polarization direction of the polarized liquid crystal in this area, even if part of the position in this area has been directly written by the thermal electric field at the previous moment.

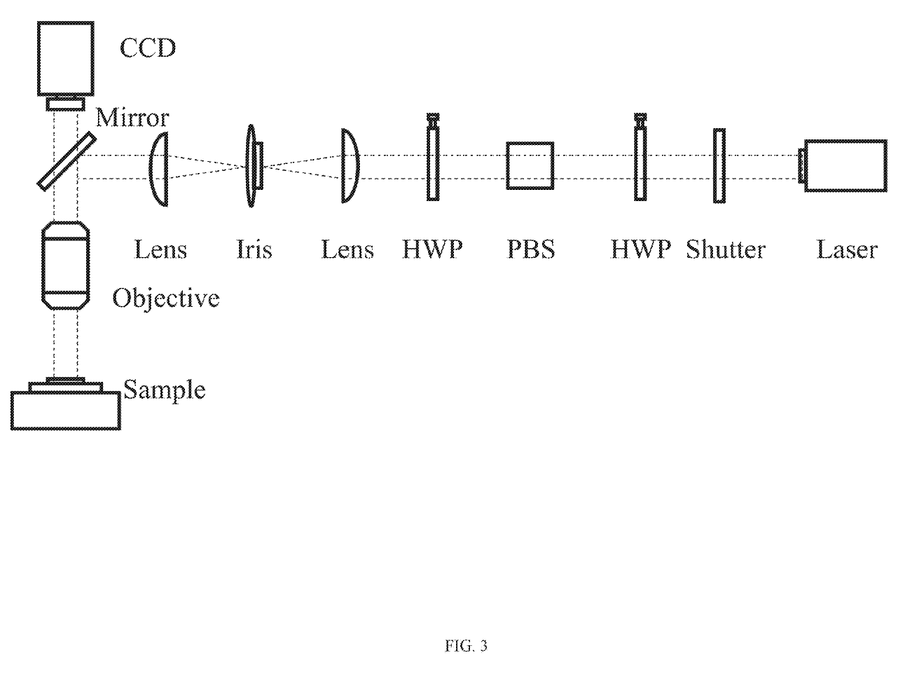

Among them, FIG. 3 is a schematic diagram of the femtosecond laser direct writing device used in the present disclosure. The device includes a femtosecond laser as a light source, a shutter, a half-wave plate, a polarization beam splitter, a polarizer, a lens, a diaphragm, a charge coupled device (CCD) camera, a reflector, a first microscope objective, a second microscope objective, a liquid crystal sample and a high-precision translation stage. Specifically, the device uses femtosecond laser with a wavelength of 800 nanometers, a duration of 75 femtoseconds and a repetition frequency of 80 megahertz for direct writing, and the laser power is adjusted through a half-wave plate and a polarization beam splitter.

Specifically, the inside of the liquid crystal cell is focused through objective lens groups which are the first microscope objective with a numerical aperture of 0.7 and a magnification of 50 times, and the second microscope objective with a numerical aperture of 0.3 and a magnification of 10 times, to generate an effective spot size of tens of micrometers. The sample is moved through a high-precision translation stage to make the focused light beam scan on the sample.

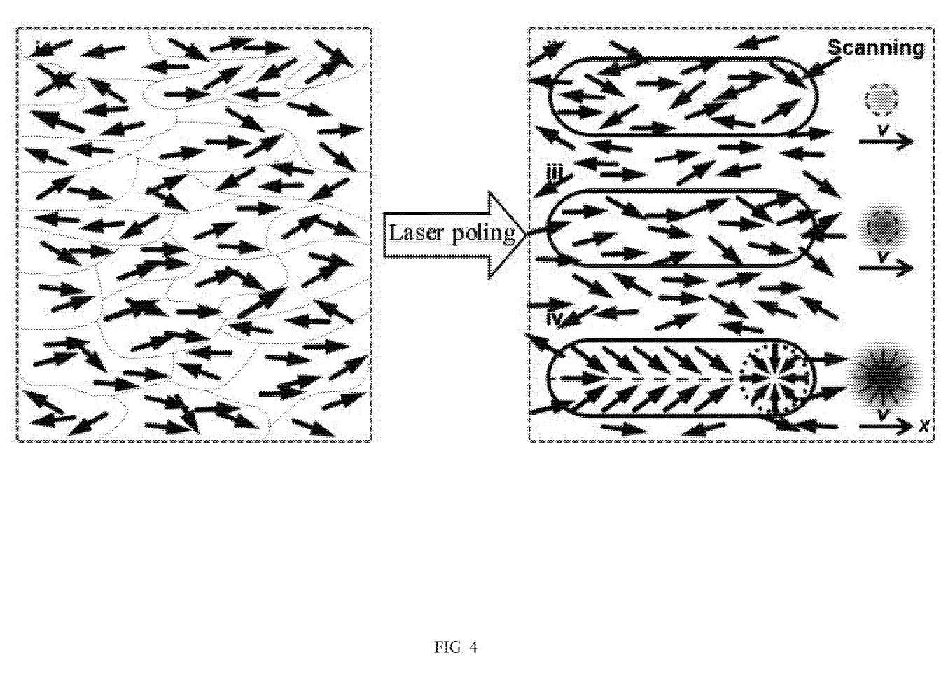

FIG. 4 is a schematic diagram of the orientation change of the femtosecond laser direct writing ferroelectric liquid crystal element prepared in this embodiment. The figure shows the change of the liquid crystal molecular orientation direction before and after femtosecond laser direct writing. Before direct writing, the orientation direction of the liquid crystal cell presents a disordered state at room temperature. After direct writing, under the action of different laser pulse energies, the liquid crystal molecular orientation state changes, showing an ordered state along the laser spot scanning direction.

From the change of the liquid crystal polarization direction after the step 5 and the step 6, it may be concluded that the alignment layer in this embodiment actually does not play a role in the prepared liquid crystal grating. Therefore, it may be inferred that the technical schemes of the present disclosure may also be without an alignment layer, which will not affect the integrity of the technical solution. However, the existence of the alignment layer still makes the sample before direct writing more uniform to a certain extent and has a certain degree of anisotropy (though very weak, the brightness difference is about 10 percent (%)).

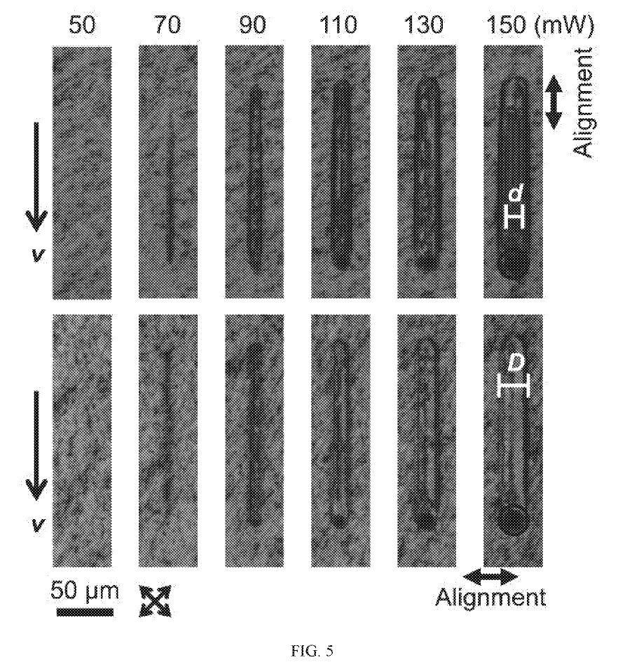

FIG. 5 is a texture diagram of the strip structure of the ferroelectric liquid crystal material at room temperature prepared in this embodiment under a polarizing microscope. Specifically, the femtosecond laser power is set to 50 megawatts (mW) to 150 mW in sequence, the power of each strip structure is changed by 20 mW, and six strip ferroelectric domain structures are obtained in the directions perpendicular and parallel to the uniform alignment direction of the liquid crystal cell. It may be seen from FIG. 5 that as the femtosecond laser power increases, the width of the strip domains increases.

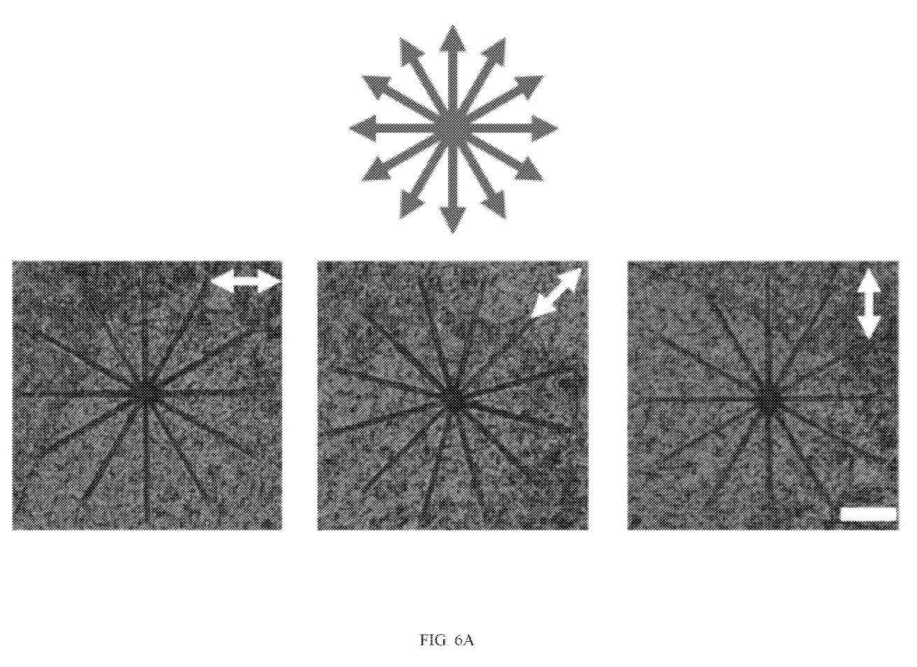

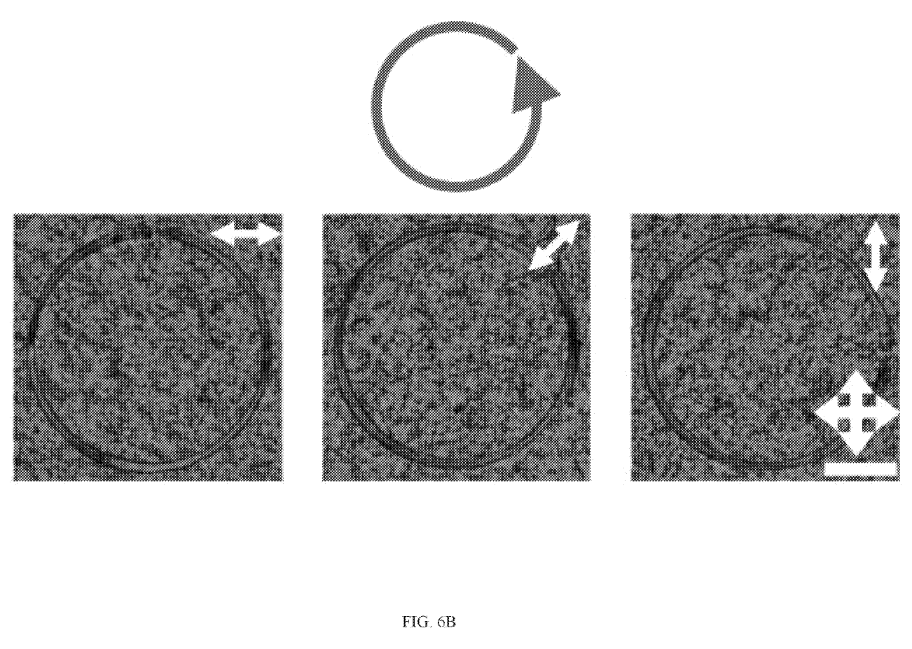

FIG. 6A is a texture diagram of the femtosecond laser direct writing radial lines patterns prepared in the present disclosure under a polarizing microscope.

FIG. 6B is a texture diagram of the femtosecond laser direct writing circular ring patterns prepared in the present disclosure under a polarizing microscope.

Among them, the radial lines are obtained by setting the femtosecond laser power to 260 mW, fixing the starting point, taking the circumference with a diameter of 200 micrometers (μm) as the end point, and directly writing 1 radial line every 30 degrees rotation along the radius direction of the circle, totaling 12 lines; the circular ring is obtained by directly writing with the circle with a diameter of 200 μm as the trajectory.

Optionally, in this embodiment, strips, radial lines and circular rings are used as the patterns for femtosecond laser direct writing, but they are not limited to these patterns, including any other patterns.

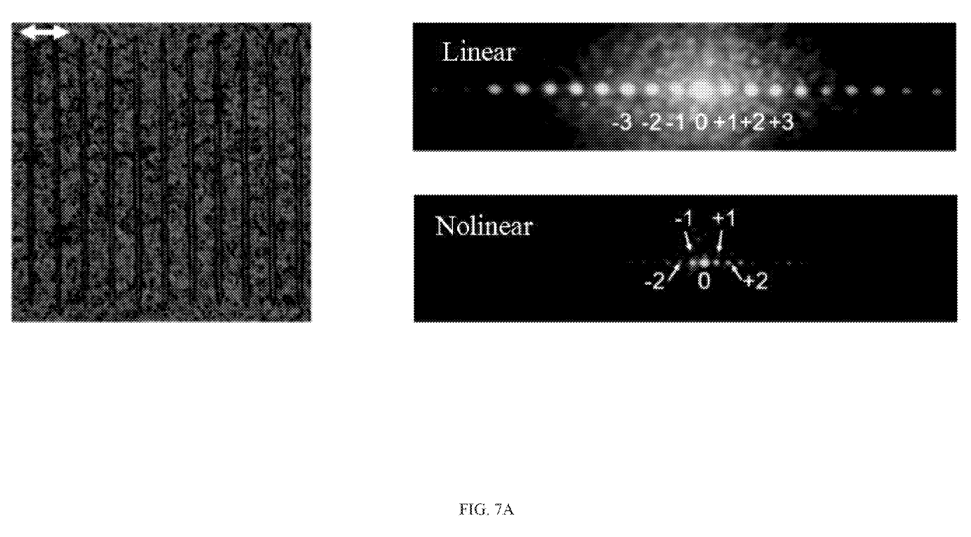

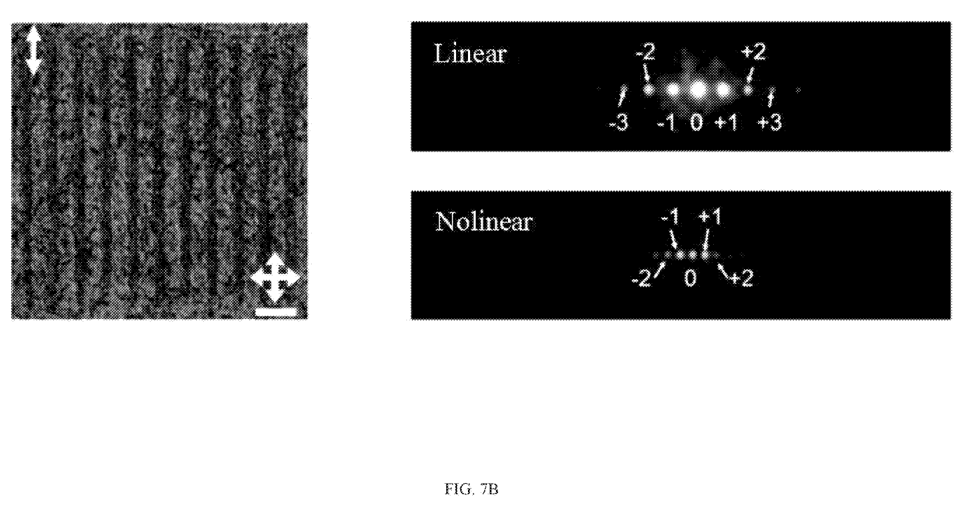

FIG. 7A and FIG. 7B are a texture diagram of the grating prepared in this embodiment under a polarizing microscope and its corresponding linear and nonlinear diffraction diagrams. The grating is formed by periodic arrangement of strip patterns. Specifically, the grating structure is directly written by setting the femtosecond laser power to 350 mW and the period to 20 μm in the directions parallel and perpendicular to the uniform alignment direction of the liquid crystal cell. The incident light wavelength is set to 800 nm, and linear and nonlinear diffraction spots of the grating are obtained respectively. The nonlinear diffraction of the grating conforms to nonlinear Raman-Nath diffraction, with symmetrically distributed multi-order diffracted lights, and the 0th-order spot has the strongest light intensity. The first-order diffraction angle of linear diffraction is twice that of nonlinear diffraction.

The present disclosure provides an idea of a preparation method and an application for a ferroelectric liquid crystal material grating at room temperature based on femtosecond laser direct writing. There are many methods and approaches to specifically implement the technical solution. The above description is only a preferred embodiment of the present disclosure. It should be pointed out that for those of ordinary skill in the art, without departing from the principle of the present disclosure, several improvements and modifications may also be made, and these improvements and modifications should also be regarded as the protection scope of the present disclosure. Each component not clearly specified in this embodiment may be realized by existing technologies.

What is claimed is:

1. A preparation method for a ferroelectric liquid crystal material grating at room temperature based on femtosecond laser direct writing, comprising following specific steps:
cleaning a first substrate and a second substrate by ultrasound, and cleaning the first substrate and the second substrate by ozone after drying to obtain a cleaned first substrate and a cleaned second substrate;
applying spacers to edges of the cleaned first substrate and the cleaned second substrate, bonding the cleaned first substrate and the cleaned second substrate in a staggered manner, and forming a liquid crystal cell after curing;
injecting a ferroelectric liquid crystal material into the liquid crystal cell to form a liquid crystal layer; and
directly writing patterns on the liquid crystal layer by a femtosecond laser direct writing device to control a molecular orientation direction of the liquid crystal layer, and obtaining the ferroelectric liquid crystal material grating;
wherein, the patterns directly written on the liquid crystal layer by the femtosecond laser direct writing device comprise any one of strip patterns, radial line patterns or circular ring patterns.

2. The preparation method according to claim 1, wherein a first alignment layer and a second alignment layer are respectively disposed on inner sides of the first substrate and the second substrate.

3. The preparation method according to claim 1, wherein a width of the strip patterns increases as femtosecond laser power in the femtosecond laser direct writing device increases.

4. The preparation method according to claim 3, wherein the femtosecond laser direct writing device comprises a femtosecond laser, a shutter, a half-wave plate, a polarization beam splitter, a polarizer, a lens, a diaphragm, a charge coupled device (CCD) camera, a reflector, a first microscope objective, a second microscope objective, a liquid crystal sample and a high-precision translation stage.

5. The preparation method according to claim 4, wherein the femtosecond laser generates laser light with a wavelength of 800 nanometers, a duration of 75 femtoseconds and a repetition frequency of 80 megahertz.

6. The preparation method according to claim 4, wherein the femtosecond laser direct writing device comprises the first microscope objective with a numerical aperture of 0.7 and a magnification of 50 times, and the second microscope objective with a numerical aperture of 0.3 and a magnification of 10 times.

7. The preparation method according to claim 1, wherein the ferroelectric liquid crystal material is ferroelectric nematic liquid crystal RM734.

8. The preparation method according to claim 2, wherein an alignment agent used in the first alignment layer and the second alignment layer comprises any one of surfactants, rubbing alignment agents, photocrosslinkable materials, photodegradable materials or photochromic cis-trans isomerization materials.

9. A ferroelectric liquid crystal material grating at room temperature based on femtosecond laser direct writing, prepared by the preparation method according to claim 1.
